(19) United States
(12) Patent Application Publication
(10) Pub. No.: US 2026/0243319 A1
(43) Pub. Date: Aug. 20, 2026

(54) MOTORLESS PARKING BRAKE

(71) Applicant: ZF Active Safety US Inc., Livonia, MI (US)

(72) Inventor: Galus Chelaidite, South Lyon, MI (US)

(21) Appl. No.: 19/053,598

(22) Filed: Feb. 14, 2025

(51) Int. Cl. F16D 65/18; F16D 27/00; F16D 55/226; F16D 55/228; F16D 121/04; F16D 125/40; F16D 127/06; F16D 129/08

(52) U.S. Cl. CPC F16D 65/183; F16D 27/004; F16D 55/226; F16D 55/228; F16D 2121/04; F16D 2125/40; F16D 2127/06; F16D 2129/08

(57) ABSTRACT

A parking brake for a wheel rotor having at least one brake pad associated therewith includes a housing defining first and second passages. First and second pistons are provided in the respective first and second passages. First and second spindles are associated with each of the respective first and second pistons such that axial translation of the pistons causes rotation of the spindles. A clutch mechanism is associated with each of the first and second spindles. Each clutch mechanism has a first condition allowing relative rotation between the spindles and the pistons such that the pistons are axially movable within the passages and into engagement with the at least one brake pad in response to hydraulic pressure applied to the pistons. Each clutch mechanism has a second condition preventing relative rotation between the spindles and the pistons such that the pistons remain engaged with the at least one brake pad when hydraulic fluid pressure is removed from the pistons to maintain clamp force at the vehicle wheel. An electromagnet assembly is associated with each clutch mechanism. Each electromagnet assembly has a first magnetic polarity for placing the clutch mechanism in the first condition and a second magnetic polarity for placing the clutch mechanism in the second condition.

### TECHNICAL FIELD

The present invention relates to braking systems and, in particular, relates to an electromechanical parking brake that maintains braking force without the use of a motor.

### BACKGROUND

Current vehicles are equipped with hydraulic service brakes and electromechanical parking brakes (EPB) for helping control vehicle braking events depending on predetermined scenarios. The service brakes rely on one or more movable pistons that selectively apply force to brake pads in order to slow down or stop rotating wheel rotors on the vehicle. The EPB can be used in conjunction with the service brakes to maintain the vehicle at a standstill on a hill.

### SUMMARY

In one example, a parking brake for a wheel rotor having at least one brake pad associated therewith includes a housing defining first and second passages. First and second pistons are provided in the respective first and second passages. First and second spindles are associated with each of the respective first and second pistons such that axial translation of the pistons causes rotation of the spindles. A clutch mechanism is associated with each of the first and second spindles. Each clutch mechanism has a first condition allowing relative rotation between the spindles and the pistons such that the pistons are axially movable within the passages and into engagement with the at least one brake pad in response to hydraulic pressure applied to the pistons. Each clutch mechanism has a second condition preventing relative rotation between the spindles and the pistons such that the pistons remain engaged with the at least one brake pad when hydraulic fluid pressure is removed from the pistons to maintain clamp force at the vehicle wheel. An electromagnet assembly is associated with each clutch mechanism. Each electromagnet assembly has a first magnetic polarity for placing the clutch mechanism in the first condition and a second magnetic polarity for placing the clutch mechanism in the second condition.

In another example, a parking brake for a wheel rotor having at least one brake pad associated therewith includes a housing defining at least one passage. A piston is provided in each passage. A spindle is associated with each piston such that axial translation of the piston causes rotation of the respective spindle. A clutch mechanism is associated with each spindle. Each clutch mechanism has a first condition allowing relative rotation between the spindle and the respective piston such that the piston is axially movable within the passage and into engagement with the at least one brake pad in response to hydraulic pressure applied to the piston. Each clutch mechanism has a second condition preventing relative rotation between the spindle and the respective piston such that the piston remains engaged with the at least one brake pad when hydraulic fluid pressure is removed from the piston to maintain clamp force at the vehicle wheel. An electromagnet assembly is associated with each clutch mechanism. Each electromagnet assembly has a first magnetic polarity for placing the clutch mechanism in the first condition and having a second magnetic polarity for placing the clutch mechanism in the second condition.

Other objects and advantages and a fuller understanding of the invention will be had from the following detailed description and the accompanying drawings.

### BRIEF DESCRIPTION OF THE DRAWINGS

FIG. 1 is a schematic illustration of a vehicle having a braking system including an example caliper assembly.

FIG. 2 is an isometric view of a housing of the caliper assembly.

FIG. 3A is a section view of the housing taken along line 3A-3A of FIG. 2.

FIG. 3B is a section view of a piston assembly and associated clutch assembly.

FIG. 4A is an exploded view of the piston assembly.

FIG. 4B is a section view of the assembled piston assembly.

FIG. 5A is an isometric view of a clevis for the clutch assembly.

FIG. 5B is a section view of the clevis taken along line 5B-5B of FIG. 5A.

FIG. 6A is an isometric view of a plug for the clutch assembly.

FIG. 6B is a section of the plug taken along line 6B-6B of FIG. 6A.

FIG. 7A is an isometric view of an electromagnet assembly of the clutch assembly.

FIG. 7B is a section view of the electromagnet assembly taken along line 7B-7B of FIG. 7A.

FIG. 8A is a top view of a portion of the electromagnet assembly.

FIG. 8B is an enlarged view of a portion of the electromagnet assembly indicated at 8B in FIG. 3B.

FIG. 9A is a section view of the caliper assembly when the clutch assembly is in a first condition.

FIG. 9B is a top view of a portion of the electromagnet assembly when the clutch assembly is in the first condition.

FIG. 10A is a section view of the caliper assembly when the clutch assembly is in a second condition.

FIG. 10B is a top view of a portion of the electromagnet assembly when the clutch assembly is in the second condition.

FIG. 11A is a front view of the caliper assembly during a first step of manually resetting the clutch mechanism.

FIG. 11B is a front view of the caliper assembly during a second step of manually resetting the clutch mechanism.

FIG. 11C is a front view of the caliper assembly during a third step of manually resetting the clutch mechanism.

FIG. 12 is a flow chart for parking brake events of the vehicle.

### DETAILED DESCRIPTION

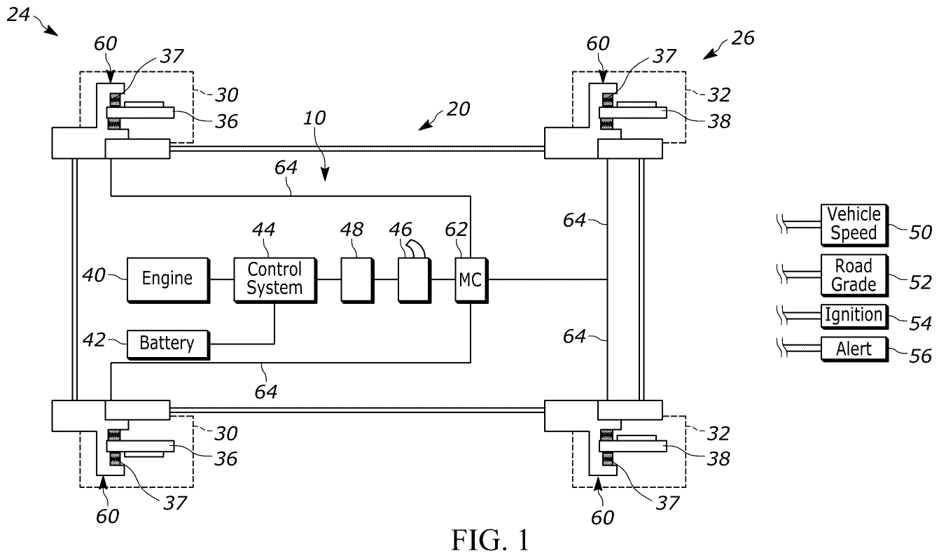

The present invention relates to braking systems and, in particular, relates to an electromechanical parking brake that maintains braking force without electrical power or hydraulic assistance. FIG. 1 illustrates an example braking system 10 for a motor vehicle 20 in accordance with the present invention. The vehicle 20 can be an electric or hybrid vehicle.

The vehicle 20 extends from a first or front end 24 to a second or rear end 26. A pair of steerable wheels 30 is provided at the front end 24. Each wheel 30 includes a wheel rotor 36 driven and steered by a steering linkage (not shown). A pair of wheels 32 is provided at the rear end 26. Each wheel 32 includes a wheel rotor 38 driven by a steering linkage (not shown). Friction brake pads 37 are associated with each wheel rotor 36, 38 and positioned on opposite sides thereof.

A propulsion system 40 including an engine and/or electric motor supplies torque to the wheels rotors 36 and/or the wheels rotors 38. A battery 42 supplies power to the vehicle 20. A brake pedal simulator 46 or brake pedal (not shown) is provided for controlling the timing and degree of vehicle 20 braking. A sensor 48 is connected to the brake pedal simulator 46 and monitors the displacement and acceleration of the brake pedal simulator.

A caliper assembly 60 is provided on at least one of the wheel rotors 36, 38 and controls both service braking and the parking brake associated with that wheel rotor. As shown, each wheel rotor 36, 38 on the front and rear ends 24, 26 includes a caliper assembly 60. It will be appreciated, however, that only the front wheel rotors 36 or only the rear wheel rotors 38 can include a caliper assembly 60 (not shown). The caliper assemblies 60 are connected to a master cylinder 62 by hydraulic lines 64. It will be appreciated that the fluid system for the caliper assemblies 60 and master cylinder 62 has been greatly simplified for brevity.

A control system 44 is provided for helping control operation of the vehicle 20, such as operation of the propulsion system 40 and vehicle braking, including operating the caliper assemblies 60. To this end, the control system 44 can include one or more controllers, such as a transmission controller, propulsion system controller, motor controller, and/or brake controller. That said, the control system 44 is connected to and receives signals from various sensors that monitor vehicle functions and environmental conditions.

For example, a vehicle speed/acceleration sensor 50 monitors the vehicle speed and acceleration and generates signals indicative thereof. A road grade sensor 52 can detect or calculate the slope of the road on which the vehicle 20 is driving and generate signals indicative thereof. An ignition sensor 54 generates signals indicative of when the ignition is turned on. The control system 44 can receive and interpret these signals and perform vehicle functions, e.g., braking, in response thereto. The control system 44 can also be connected to an alert 56 for notifying the driver/operator of the vehicle 20 of vehicle conditions, vehicle status, and/or environmental conditions.

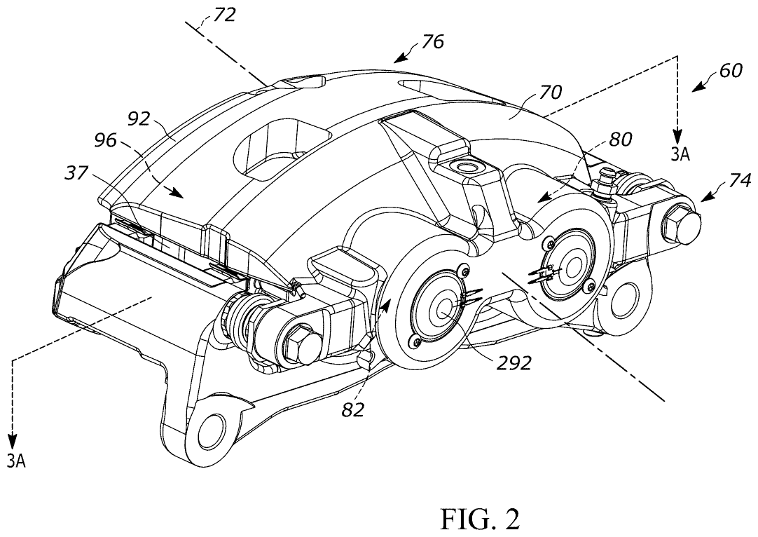

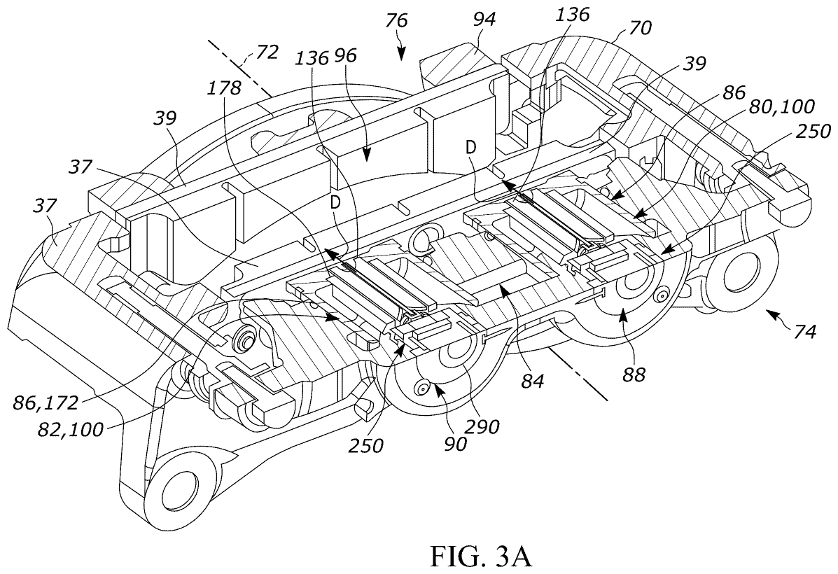

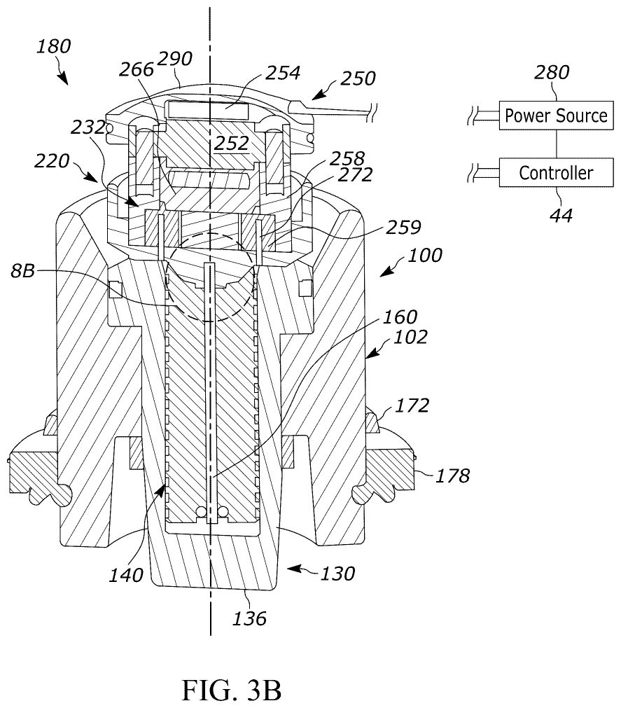

Referring to FIGS. 2 and 3A, the caliper assembly 60 includes a housing 70 that extends generally along a centerline 72 from a first end 74 to a second end 76. First and second bores or passages 80, 82 (see FIG. 3A) extend into the housing 70 and parallel to the centerline 72. A passage 84 fluidly connects the first and second passages 80, 82 and is configured to receive hydraulic fluid from the hydraulic lines 64. An annular recess or seal groove 86 is provided in each passage 80, 82. Openings 88, 90 extend axially through the first end 74 of the housing 70 to the respective passages 80, 82.

A bridge 92 extends from the second end 74 of the housing 70 and along/parallel to the centerline 72. A projection 94 extends from the bridge 92 and transverse to the centerline 72. The bridge 92 and projection 94 cooperate to define a channel 96 for receiving the rotor 36 or 38 of one of the wheels 30 or 32. The friction brake pads 37 oppose one another within the channel 96 on opposite sides of the rotor 36 or 38. The friction brake pads 37 are held by backing plates 39.

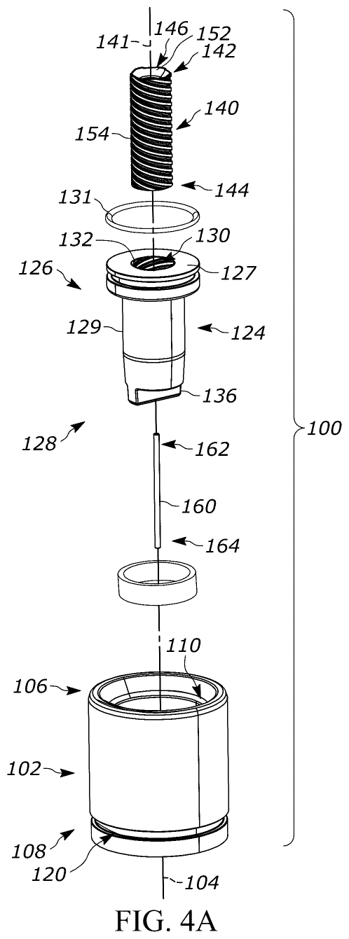

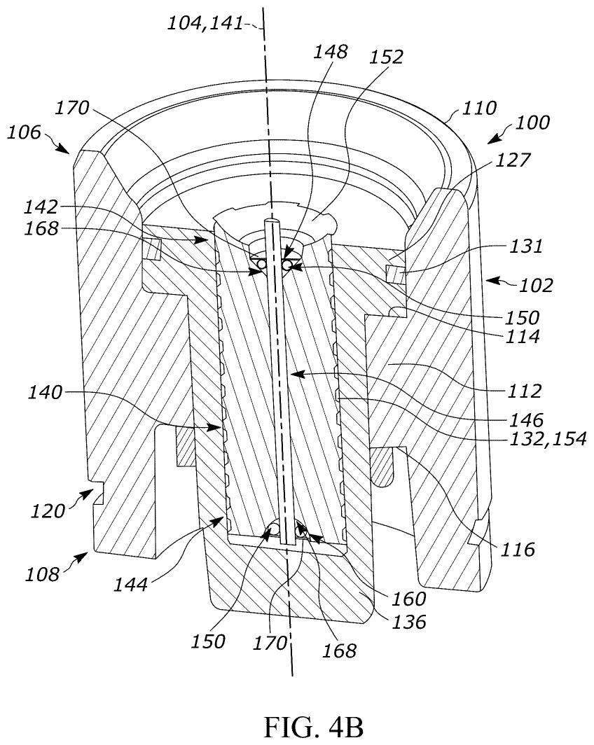

Referring to FIGS. 3B-4B, a piston assembly 100 is provided in each passage 80, 82 in the housing 70. The piston assembly 100 includes a piston 102 extending along a centerline 104 from a first end 106 to a second end 108 (see FIGS. 4A-4B). A passage 110 extends the entire length of the piston 102 from the first end 104 to the second end 108. A projection or shoulder 112 extends radially inward into the passage 110 and defines first and second end surfaces 114, 116 facing away from one another towards the respective ends 106, 108. The projection 112 is positioned generally along the middle of the length of the piston 102 and extends a predetermined distance along the length of the piston, as will be discussed.

An annular recess 120 is provided on the exterior of the piston 102 at the second end 108 thereof. The piston 102 is formed from a material that is durable especially in compression and but also, to a limited extent, in tension, e.g., steel, aluminum or similar material. As shown, piston 102 is made of phenolic as the piston mainly supports compressive loads.

A cylindrical nut 124 (FIG. 4A) extends longitudinally from a first end 126 to a second end 128. The nut 124 includes a head or flange 127 and a shaft 129 extending longitudinally from the head. A passage 130 extends the entire length of the nut 127. A rubber seal 131 is positioned in an annular recess in the flange 127 and encircles the flange. Threads 132 are provided along a portion of the passage 130 at the first end 126. An anti-rotation feature, namely, a projection 136 extends longitudinally from the shaft 129 away from the head 127.

Turning to FIG. 4B, the nut 124 extends through the passage 110 in the piston 102 with the second end 128 extending beyond the second end 108 of the piston. The head 127 abuts the end surface 114 of the shoulder 112 and the shaft 129 of the nut 124 is light press-fit with the shoulder to rigidly fix the nut and piston together. At the same time, the rubber seal 131 engages the inner surface of the piston 102 defining the passage 110. This both seals the piston 102 and nut 124 together while preventing rotation of the nut relative to the piston.

A spindle 140 extends along an axis 141 from a first end 142 to a second end 144. A central passage 146 extends the entire length of the spindle 140. A first countersink 148 is provided at the first end 142 and aligned with the central passage 146. A second countersink 150 is provided at the second end 144 and aligned with the central passage 146. The first end 142 also includes a tapered/domed axial end surface 152. Threads 154 are provided along the exterior of the spindle 140 and are configured to mate with the threads 132 on the nut 124, which positions the spindle 140 within the passage 110 of the piston 102. The second end 144 of the spindle 140 is positioned adjacent to but longitudinally spaced from the bottom of the passage 130 in the nut 124.

Since the nut 124 is rigidly fixed to the piston 102, the mating threads 132, 154 establish a threaded connection between each spindle 190 and corresponding piston 102. It will be appreciated that the mating threads 132, 154 can be configured to be “fast lead” threads. That is to say, the threads 132, 154 can be configured to have mating fast-pitch constructions that facilitate relative rotational and translational movement between the nut 124 and the spindle 140, which facilitates relative movement between the piston 102 and the spindle.

An axle 160 extends through the central passage 146 of the spindle 140 from a first end 162 to a second end 164. The first end 162 extends out of the first countersink 148. The second end 164 is positioned within the second countersink 150. The axial extents of the second ends 144, 164 can be co-planar.

Bearings 168 are provided in the radial space between the ends 162, 164 of the axle 160 and the corresponding ends 142, 144 of the spindle 140. In particular, a first series of bearings 168 is positioned within the first countersink 148 and encircle the first end 162 of the axle 160. A second series of bearings 168 is positioned within the second countersink 150 and encircle the second end 164 of the axle 160. Retaining rings 170 are fixed to the ends 162, 164 of the axle 160 for retaining the bearings 168 in the respective countersinks 148, 150. In this manner, the spindle 140 is allowed to rotate—but not translate—relative to the axle 160 while being threadably engaged with the nut 124.

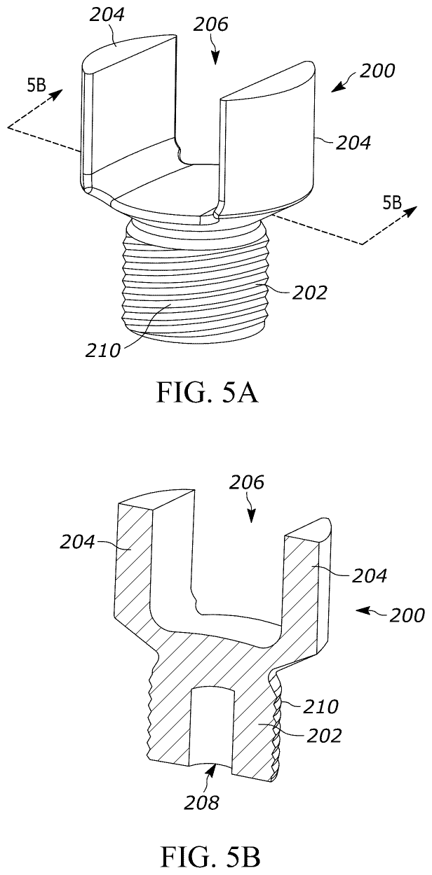

Returning to FIG. 3B, a clutch mechanism or unit 180 is connected to the spindle 140. As will be discussed, the clutch mechanism 180 has a first condition allowing the spindle 140 to rotate as needed and a second condition preventing rotation of the spindle. The clutch mechanism 180 includes a clevis 200 (FIGS. 5A-5B) having a base 202. A pair of arms 204 extend away from the base 202 and parallel to one another to define a receiving space 206. A blind passage 208 extends into the base 202 towards the arms 204 and is configured to receive the first end 162 of the axle 160 in a press-fit manner. Threads 210 are formed along the exterior of the base 202. The clevis 200 is made of a non-magnetic material, such as stainless steel.

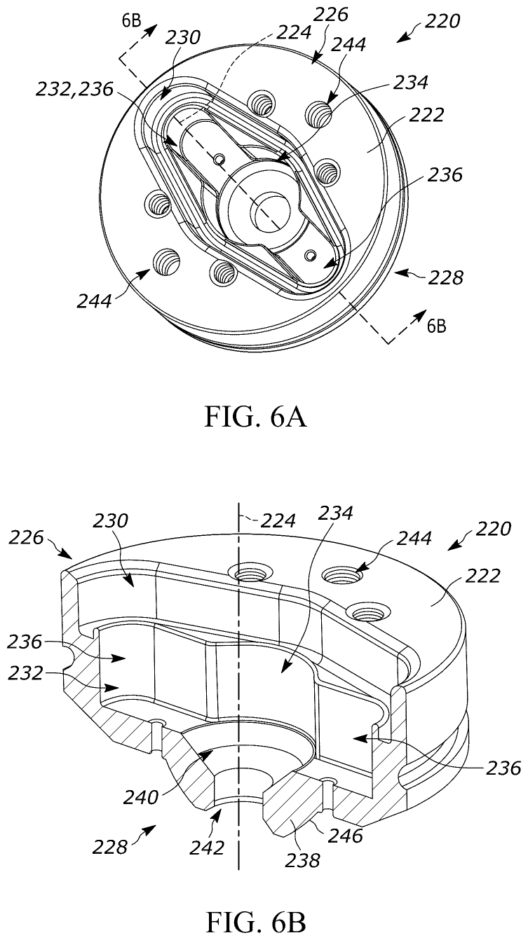

The clutch mechanism 180 also includes a plug 220 (FIGS. 6A-6B) having a base 222 extending generally along a centerline 224. The base 222 includes a first side 226 and a second side 228. A stepped recess extends from the first side 226 of the base 222 towards the second side 228 and includes a first portion 230 and a second portion 232. The first portion 232 is generally oblong. The second portion 232 has a circular center 234 and a pair of radially projecting arms 236.

A projection 238 extends from the second side 228. The projection 238 includes an inner, tapered recess 240. A threaded passage 242 extends from the end of the recess 240 to the end of the projection 238. The projection 238 has a tapered/domed outer surface 246. Threaded passages 244 are provided on opposite sides of the stepped recess 230, 232 and extend towards the second side 228 of the base 222. The plug 220 is made of a high strength non-magnetic material such as stainless steel.

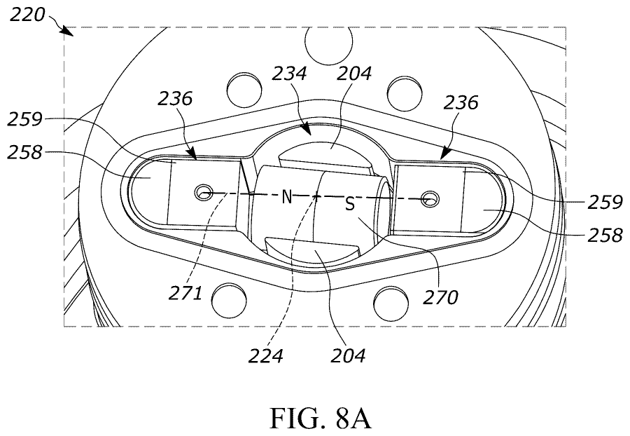

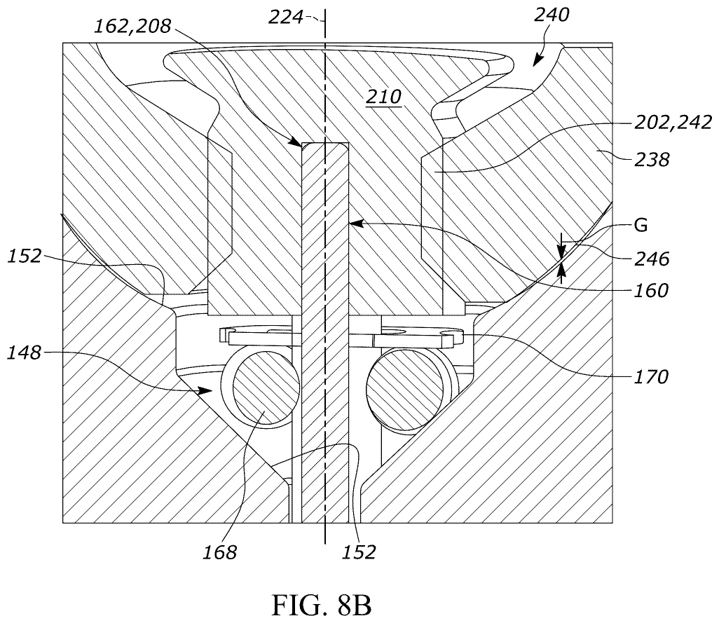

A permanent magnet 270 is shown (FIG. 8A) fitted between the arms 204 of the clevis 200, as well fitted inside the pocket 234 of the plug 220, and finally, also fitted between the two “arms” 259 of the electromagnet assembly 250. The arms 259 are aligned with one another along a common centerline 271 that intersects the centerline 224.

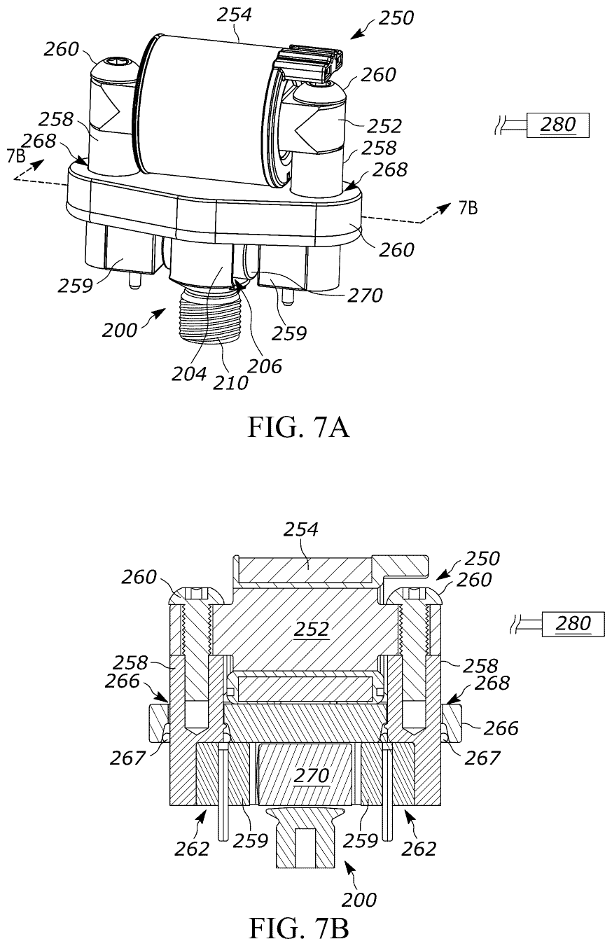

An electromagnet assembly 250 (FIGS. 7A-7B) is “coupled” to the clevis 200 via the permanent magnet 270 for helping to switch the clutch mechanism 180 between the first and second conditions. In one example, the electromagnet assembly 250 is designed as a bi-stable rotary solenoid having a having a positive voltage polarity position and a negative voltage polarity position. That said, the electromagnet assembly 250 is motor-less, gear-less, and does not require a constant voltage application to maintain any one position.

The electromagnet assembly 250 includes a ferritic core 252 and a coil 254 wrapped around the core. Ferritic legs 258 extend from opposite ends of the core 252 and are secured thereto by fasteners 262. In one example, each leg 258 directly contacts the core 252 and includes a notch 262 for receiving a ferritic portion 259. In this manner, the components 252, 258, 259 are all considered part of the same electromagnetic core 252. With that in mind, it will be appreciated that the core 252 could be formed in a substantially single U-shaped component (not shown) such that the legs 258 and portions 259 are integrally formed with the core 252.

A power source 280 is connected to the coil 254 for selectively supplying power thereto. In case of multiple electromagnet assemblies 250, each of the coils 254 is connected in parallel to the power source 280. The power source 280 can be, for example, the vehicle battery 42 and/or a separate, on-board battery (not shown). In any case, the power source 280 can supply a voltage to the electromagnet assemblies 250 having either an electrical polarity A or an opposite electrical polarity B, thereby generating magnetic fields in the electromagnet cores 252 having magnetic polarity NS or SN such that the permanent magnet 270 can align with the magnetic fields according to the set magnetic polarity. A cap 290 covers the electromagnet assembly 250, thereby sealing it for protection from debris intrusion while helping to route electrical wires between the coil and the power source 280.

The electromagnet assembly 250 does not generate a magnetic field until/unless electrical current is supplied to the coil 254. Furthermore, the magnetic field polarity can be switched depending on the electrical voltage polarity used to power the electromagnet assembly 250. A controller or control system, e.g., the control system 44, can be responsible for selectively supplying power from the power source 280 to the electromagnet assembly 250 and dictating the polarity A or B of said power.

As shown, the legs 258 extend through openings 268 in a cap 266 and position the portions 259 on opposite sides of the cap from the core 252 and coil 254. Each of the legs 258 is sealed relative to its opening 268, e.g., an O-ring 267 seals the interface between the leg and respective opening, to prevent the passage of brake fluid upwards (as shown) into the electromagnet 250. In this manner, the seals 267 help to delineate between the atmospheric and hydraulic sides of the clutch mechanism 180.

A permanent magnet 270 is positioned between and aligned along its length with the portions 259. More specifically, the permanent magnet 270 is positioned between the portions 259 of the electromagnetic core 252 on opposite sides of the cap 266 from the electromagnetic coil 254. In this example, the permanent magnet 270 has a S/N (right/left) configuration. The reverse configuration for the permanent magnet 270 is contemplated.

The clevis 200 is positioned such that the permanent magnet 270 resides in the receiving space 206 between the arms 204. In one example, the arms 204 face towards opposite sides of the length of the permanent magnet 270. Consequently, the ends of the permanent magnet 270 are positioned in the vicinity of the portions 259 of the legs 258. That said, changes in the polarity of the current applied to the coil 254 will affect how the coil [through the portions 259] and permanent magnet 270 magnetically interact with one another.

The electromagnet assembly 250 and clevis 200 are arranged in the plug 220 as shown in FIG. 3B. To this end, the cap 266 is positioned within the first portion 230 of the stepped recess in the plug 220. A seal (not shown) extends around the interface between the cap 266 and the first portion 230. Spring pins 272 locate the second components 259 on and relative to the plug 220.

The arms 204 of the clevis 200 and the permanent magnet 270 are positioned within the circular center 234 of the second portion 232. The arms 204 are spaced radially inward from the surface of the plug 220 defining the circular center 234. The adjacent ferritic portions 259 and portions of the legs 258 engaged therewith are positioned within the radially projecting arms 236 of the second portion 232.

Turning to FIG. 8B, the base 202 of the clevis 200 is positioned within the tapered recess 240 of the plug 220 and the threads 210 on the clevis 200 are engaged with the threads 242 on the plug. This arranges the clutch surfaces 152, 246 of the spindle 140 and plug 220, respectively, confronting one another but initially spaced apart.

A piston assembly 100 and corresponding clutch assembly 180 are provided in each of the passages 80, 82 in the housing 70. In particular, and referring back to FIG. 3A, the first ends 106 of the pistons 102 are positioned closer to the first side 74 of the housing 70 while the second ends 106 are positioned closer to the second side 76. A seal 172 extends around the exterior of the second end 108 of each piston 102. The seals 172 are positioned in the seal grooves 86 in the first and second passages 80, 82 and configured to cooperate with the seal grooves to seal the piston 102 within the respective passage. A piston boot excluder 178 is provided in the outer recess 122 of each piston 102 and cooperates with the housing 70 to help prevent dirt and debris from entering the passages 80, 82.

Each electromagnet assembly 250 is aligned with one of the openings 88, 90 in the housing 70 and associated with one of the respective piston assemblies 100. In particular, as noted, the axles 160 couple the clevis 200 of each clutch mechanism 180 to the spindle 140 of each piston assembly 100. The electromagnet assembles 250, in turn, are coupled to the clutch mechanisms 180. With this in mind, the electromagnet assemblies 250 are controlled in order to magnetically change the conditions of the respective clutch mechanism 180, thereby affecting the manners in which the spindles 140 can rotate.

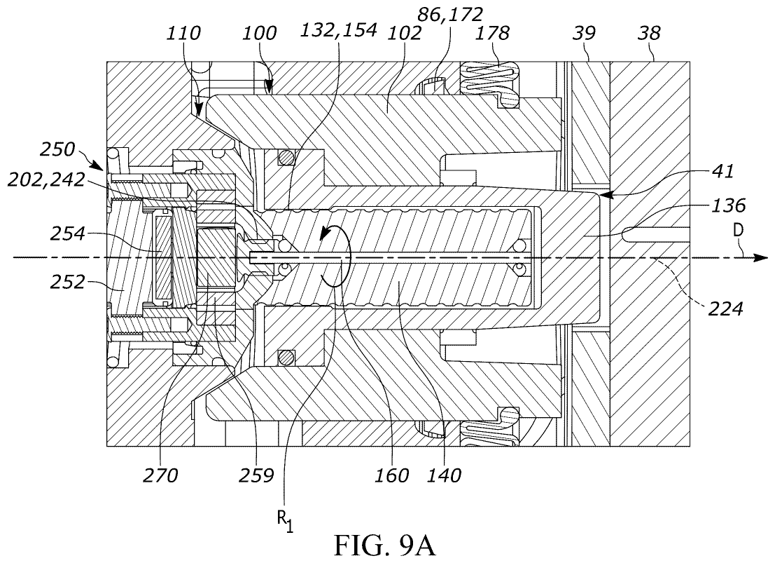

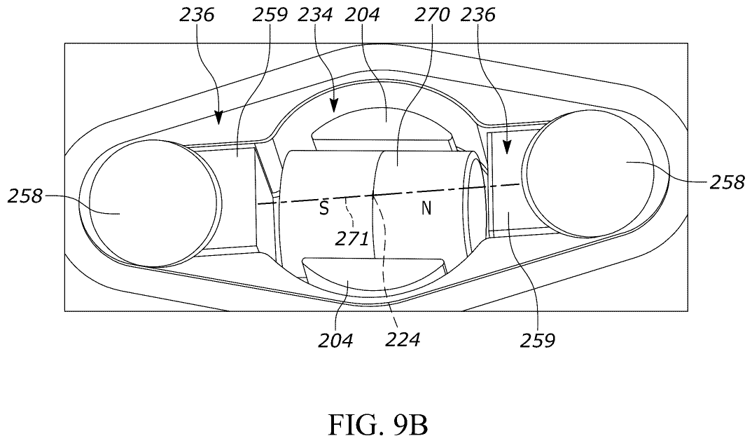

In one example shown in FIGS. 9A-9B, the electromagnet assembly 250 can be placed in a first, e.g., positive, voltage polarity position in which the permanent magnet 270 is between 5-10 degrees from being longitudinally aligned along its length with both legs 259. In other words, the length of the permanent magnet 270 is angled about 5-10 degrees relative to the centerline 271 extending between the legs 259. This is achieved by an internal stop between the clevis and the plug (not shown). To achieve this position, the coil 254 is powered to have an electrical polarity A that is attracted by both ends S/N of the permanent magnet 270. In particular, a magnetic field having the electrical polarity A is generated in the coil 254, which is imparted to/through the core 252 and ultimately to the portions 259 coupled to the core. Since the portions 259 are in close proximity to the ends S/N of the permanent magnet 270, the magnetic fields of the portions 259 interact with the respective magnetic fields of the permanent magnets to orient the permanent magnet 270 in the manner shown in FIG. 9B by initially repelling and, as the permanent magnet rotates due to the repelling force, as the permanent magnet NS axis just rotates past 90 degree alignment with axis 271, the attractive force increases between the respective ends of the permanent magnet and legs 258.

In this position, the clutch mechanism 180 is in the first condition/position allowing the spindle 140 secured thereto to rotate about the axle 160 in either the clockwise or counterclockwise direction in response to the movement of the piston 102 due to the introduction or removal of pressurized hydraulic fluid into the piston cavities 80, 82. To this end, when the electromagnet assembly 250 is in the first voltage polarity position, the clevis 200—which rotates with the permanent magnet 270 relative to the plug 220 via the threaded connection 202, 242—is located axially relative to the plug such that the clutch surfaces 152, 246 are spaced apart from one another by a gap G (see FIG. 8B). This allows for free rotation of the spindle 140 relative to the nut 124 in any direction and bound only by the threaded connection 132, 154 therebetween. The permanent magnet 270 remains in this orientation when the voltage supply thereto is shut off because the permanent magnet will be attracted to one of the legs 259 thereby securely or firmly holding this position under all and any conditions the vehicle might encounter.

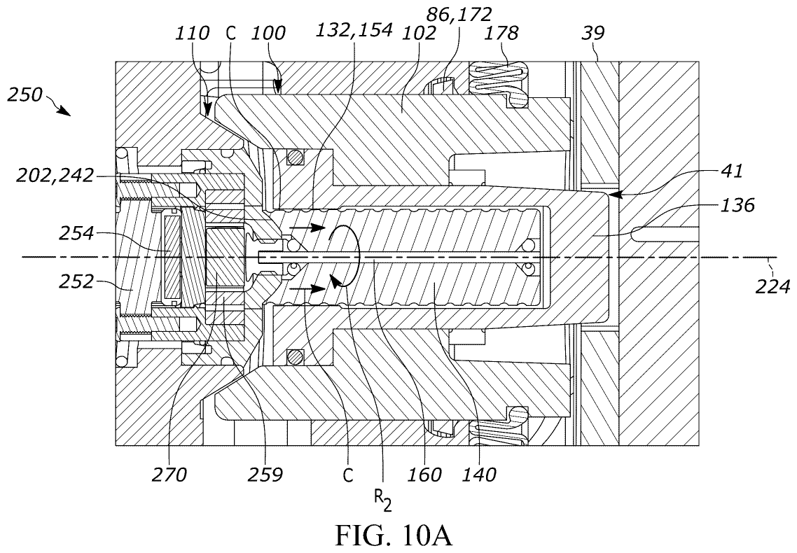

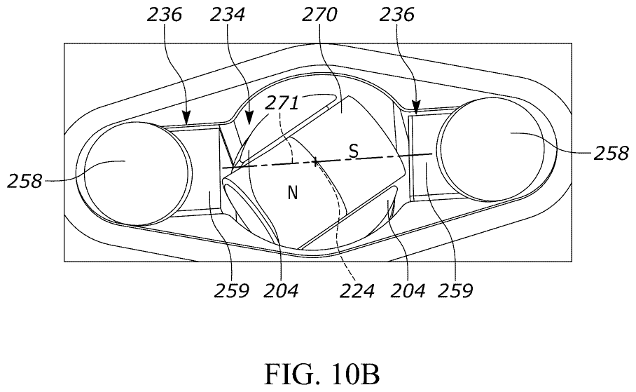

On the other hand, the electromagnet assembly 250 can be placed in a second, e.g., negative, voltage polarity position (FIGS. 10A-10B) in which the permanent magnet 270 is rotated 150 to 170° about the centerline 271 between the two legs 259, i.e., the ends S/N switch which leg 259 each respectively confronts. To achieve this orientation, the coil 254 is powered to have an electrical polarity B that is repelled by both ends S/N of the permanent magnet 270. The rotation amount of the permanent magnet 270 is defined by the engagement of the clutch, the spindle contacts the plug. In particular, a magnetic field having the electrical polarity B is generated in the coil 254, which is imparted to/through the core 252 and ultimately to the portions 259 coupled to the core. Since the portions 259 are in close proximity to the ends S/N of the permanent magnet 270, the magnetic fields of the portions 259 interact with the respective magnetic fields of the permanent magnets to orient the permanent magnet 270 in the manner shown in FIG. 10B by initially repelling and, with increasing permanent magnet rotation described previously, then attracting the respective ends of the permanent magnet.

It will be appreciated that the electromagnet assembly 250 can instead be configured such that repelling the permanent magnet 270 ends places the clutch mechanism 180 in the first condition and attracting the permanent magnet ends places the clutch mechanism in the second condition. In each instance, the electrical polarity A, B of the power delivered to the coil 254 causes the core 252 to interact with the ends S/N of the permanent magnet 270 to thereby rotate the permanent magnet to the desired orientation in order to engage or disengage the clutch.

Regardless, in this position, the clutch mechanism 180 is placed in the second condition/position preventing rotation of the spindle 140 about the axle 160 in the clockwise direction but allowing for counterclockwise rotation. In this position, the gap G is eliminated. To this end, rotation of the permanent magnet 270 to the second position causes the arms 204 of the clevis 200 to orbit the centerline 224. The clevis 200 rotates relative to the plug 220 through the threaded connection 202, 242 therebetween. This rotation, in turn, causes the clevis 200 to translate axially relative to the plug 220 and away from the electromagnet assembly 250 in the manner C.

As noted, the axle 160 is fixed to the clevis 200 and the spindle 140 is axially movable with the axle due to the retaining rings 170 and bearings 168. Consequently, this translation of the clevis 200 causes both the axle 160 and spindle 140 to move with the clevis in the same direction C away the electromagnet assembly 250 until the clutch surfaces 152, 246 engage another. The spindle 140 rotates through the threaded connections 132, 154 between the spindle and nut 124 to accommodate its axial movement.

That said, once the clutch surfaces 152, 246 are engaged, the spindle 140 is prevented from rotating in a manner that would cause the piston 102 to move toward and relative to the spindle. At the same time, the spindle 140 is allowed to rotate in a manner that causes the piston 102 to move away from and relative to the spindle. It will be appreciated that the threads 154 on the spindle 140 can be configured such that the interface between the clutch surfaces 152, 246 occurs at an almost equal but smaller diameter than the root diameter of the spindle threads 154.

Regardless of the polarity orientation of the permanent magnet 270, once power is removed from the coil 254 the permanent magnet remains in the same rotational position as it was before power was removed. Consequently, the permanent magnet 270—and therefore the clevis 200 secured thereto—are actively held in either the first position (FIG. 9A) or in the second position (FIG. 10A) by the portions 259 regardless of whether the coil 254 is powered due to the close proximity of the permanent magnet 270 ends S/N to the portions 259. This configuration allows the clutch mechanism 180 to be stable in both rotational positions of the permanent magnet 270 even if there is a malfunction of the electromagnet assembly 250. thereto this end, the clutch mechanism 270 is prevented from spontaneously engaging or disengaging once it has been set into position regardless of external vibrations or accelerations such as would occur during vehicle shipment.

Returning to FIG. 3A, during operation of the braking system 10, the controller 290 directs electric power of polarity A from the power source 280 to the electromagnet assembly 250 to place the electromagnetic assembly in the first voltage polarity position. A service brake demand initiated by the system and/or vehicle operator causes hydraulic fluid to be delivered via the hydraulic line 64 to the housing 70 of at least one caliper assembly 60. In this example, service braking is shown for a single, rear end 26 wheel rotor 38.

The hydraulic fluid passes into the connecting passage and subsequently into both the first and second passages 80, 82. The hydraulic fluid pressure builds within the passages 80, 82 and behind/upstream of the clips 170 in the passages 110 of the piston assemblies 100 until the fluid pressure is sufficient to urge the pistons 102 in the direction D towards the wheel rotor. More specifically, the pistons 102 are urged to move axially in the direction D but initially encounter the connection between the threaded components 132, 154.

At this time, the clutch unit 180 is in the first condition allowing free rotation of the spindles 140 about their respective axes 194 in either direction. That said, urging the pistons 102 to move in the direction D causes the spindles 140 connected thereto to rotate in the direction R₁ (see FIG. 9A) relative to the pistons due to the threaded connection 132, 154. More specifically, the pistons 102 move in the direction D and with the associated nuts 124 fixed thereto, the nuts 124 likewise move in the direction D. The projections 136 on the nuts 124 extend into corresponding recesses 41 in the backing plates 39 in order to prevent rotation of the nuts, thereby preventing rotation of the pistons 102. Rotation of the pistons 102 is not expected, but, to mitigate unforeseen circumstances, the nuts 124 have projections 136 which engage corresponding recesses 41 in the backing plates 39. Consequently, the axially moving nuts/pistons 102, 124 impart rotation on the spindles 140 through the threaded connections 132, 154.

Each spindle 140 rotates relative to its axle 160 and corresponding clevis 160, which remain stationary. The disengaged clutch surfaces 152, 246 therefore allow the spindles 140 to rotate to accommodate axial movement of the pistons 102 towards and into engagement with the brake pad 37 on the wheel rotor 38. Consequently, the service brake is applied and the bridge 92 of the housing 70 elastically deforms in a known manner.

Advantageously, the pistons 102 can move in the direction D independent from one another when the clutch unit 180 is in the first condition as each spindle 140 is free to rotate independent of the other. As a result, the pistons 102 can move different distances in the direction D to account for pad and/or rotor wear. For example, the piston 102 in the first passage 80 can move a first distance in the direction D before engaging the brake pad 37. If the brake pad 37 is worn, however, the piston 102 in the second passage 82 may be required to move a second, greater distance in the direction D before engaging the brake pad. In each case, the fast lead connection 142, 202 facilitates rapid piston 102 movement in the direction D with little frictional resistance between the moving threads. Consequently, both pistons 102 will reach the brake pad 37 at substantially the same time regardless of any disparity in the degree of movement needed.

In any case, if the demand for service brakes is stopped, hydraulic fluid is no longer supplied to the passages 80, 82 and, thus, the pistons 102 are no longer urged in the direction D towards the brake pad 37. This allows the elastically deformed bridge 92, housing 70, and pads 37 to automatically relax and push the pistons 102 back towards the respective passages 80, 82 in the direction opposite the direction D. The clutch units 180 remain in the first condition during this return and, thus, the spindles 140 are free to rotate in the direction opposite the direction R₁ to accommodate the axial return movement of the pistons. The fast lead threaded connection 132, 154 facilitates a rapid, reduced stress retreat of the pistons 102 away from the brake pad 37.

On the other hand, if the parking brake is demanded during application of the service brake, when the desired parking clamp force has been achieved via hydraulic pressure, the clutch units 180 are actuated to the second condition to lock the pistons 102 against the brake pad 37. More specifically, the controller 44 directs electric power of polarity B from the power source 280 to the electromagnet assembly 250 to place the electromagnetic assembly in the second voltage polarity position. This moves each respective clevis 200, axle 160, and spindle 140 as collective units toward from the electromagnetic assembles 250 in the manner C, engaging the clutch surfaces 152, 246 together and thereby locking the spindles 140 in place to prevent rotation of the spindles in the direction R₂ (opposite the direction R₁). To this end, rotation of the spindles 140 in the direction R₂ (back-drive) is prevented, whereas rotation of the spindles in the direction R₁ is permitted to enable the pistons 102 to advance further in the direction D where the application of additional hydraulic pressure is desired. Further rotation of the spindles 140 can be generated if the hydraulic pressure applied to the pistons 102 is increased. The increased pressure relieves the load at the clutch allowing the spindles 140 to rotate more according to the applied pressure. When the hydraulic pressure is released, the increased clamp force is maintained due to the repositioned spindles 140 on the clutch unit 180.

That said, when the clutch unit 180 is in the second condition and hydraulic pressure is released/removed, the pistons 102 cannot translate along/relative to the spindles 140 due to the threaded connection 132, 154 therebetween—the spindles will not rotate to enable piston translation. The pistons 102 are therefore locked in place so long as the electromagnet assembly 250 is in the second condition.

Advantageously, this allows the brake system to remove the hydraulic pressure from the caliper 60. In other words, the hydraulic fluid can be removed from the passages 80, 82 since the clutch unit 180 maintains the braking pressure between the pistons 102 and brake pad 37. The braking system 10 therefore does not rely on hydraulic fluid/pressure in order to hold the parking brake and is capable of maintaining substantially the same braking clamp force as the hydraulic system.

When the parking brake is no longer needed, e.g., drive-away release (DAR) or parking release event, hydraulic pressure is generated to the level previously applied to park the vehicle, then the electromagnetic assembly 250 is actuated to the first polarity voltage position to translate the clevis 200—and thereby translate the axle 160 and spindle 140 secured thereto—in the direction D. This disengages the clutch surfaces 152, 246 from one another to enable bidirectional rotation of the spindles. The hydraulic pressure can then be released such that the pistons 102 can retract into the passages 80, 82 and release load from the pads to allow for vehicle movement.

At the same time, hydraulic fluid is returned to the passages 80, 82 at an increased level, e.g., a 5% or 10% increase, relative to the hydraulic pressure previously applied at the time the parking brake was engaged (when the electromagnetic assembly 250 moved to the second condition). As noted, the clutch unit 180 allows for additional rotation of the spindles 140 in the direction R₁ to enable the pistons 102 to provide this additional/elevated clamping force. The increased hydraulic pressure on the pistons 102 helps to relieve the torque experienced by the spindles 140 and clevis 200.

In other words, the increased hydraulic pressure facilitates movement of the electromagnetic assembly 250 back to the first condition. That said, moving the clutch surfaces 152, 246 out of engagement with one another coupled with subsequent hydraulic pressure release enables rotation of the spindles 140, which allows the pistons 102 to move axially along and relative to the spindles back to their initial condition under the influence of the relaxing bridge 92 of the housing 70.

It will be appreciated that the clutch mechanism 270 can be engaged or disengaged whether hydraulic pressure is applied or not because the moving parts, namely, the clevis, the permanent magnet 270, the axle, and the spindle, are all inside the brake fluid. Therefore, hydraulic pressure does not affect the function of these moving parts.

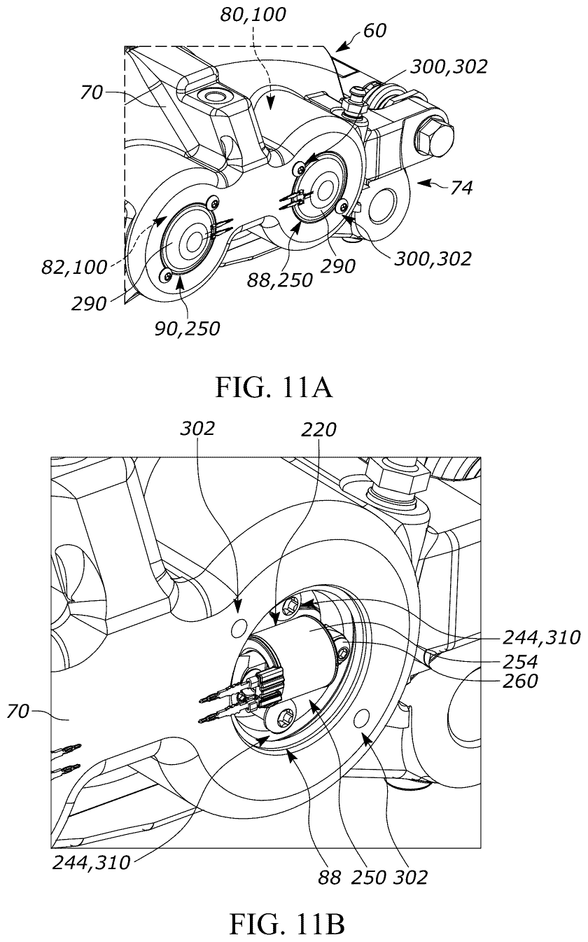

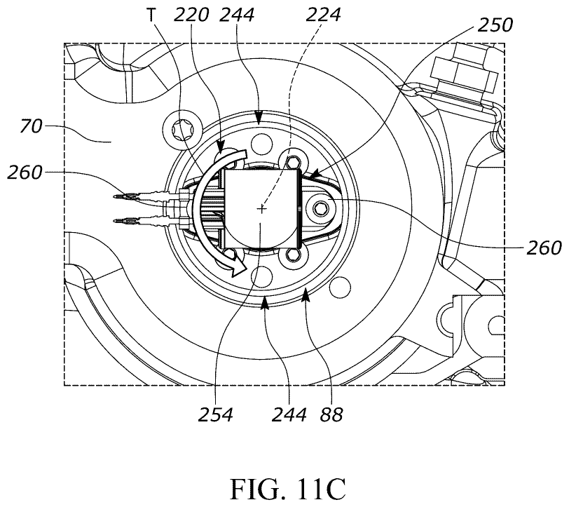

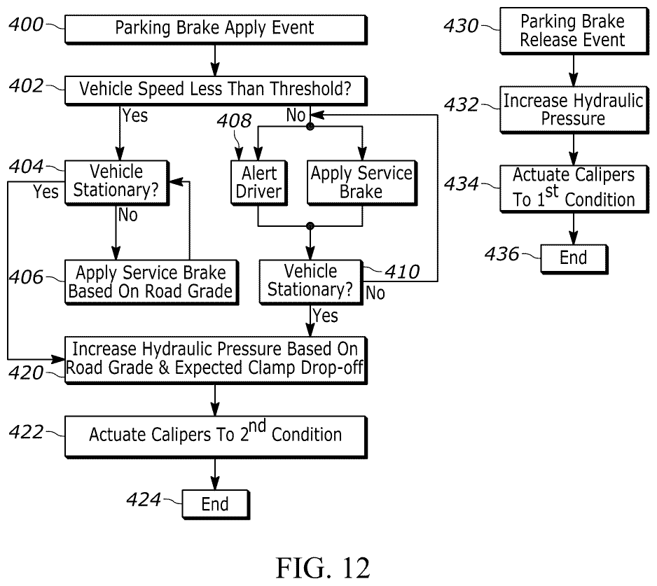

FIGS. 11A-11C illustrate one example procedure by which the parking brake can be manually released in the event of a malfunction, e.g., a power failure. As shown in FIG. 11A-11B, the cap 290 for each electromagnet assembly 250 is held in place between fasteners 300 threaded into openings 302 in the housing 70 and fasteners 310 threaded into the passages 244 in the plug 220. More specifically, the cap 290 is pinned between the heads of the fasteners 300 and the heads of the fasteners 310.

When a malfunction occurs in the electromagnet assembly 250 while the parking brake is applied, the fasteners 300 are removed and the cap 290 lifted to access the opening 88 or 90 (in this instance the opening 88). The fasteners 310 are then removed from the passages 244. This allows a tool (not shown) to be attached with fasteners to the threaded passages 244 (FIG. 11C). Once attached, the tool can be rotated about the centerline 224 of the plug 220 to apply torque to the plug in the manner T (counterclockwise as shown).

Rotating the plug 220 about the centerline 244 in this manner causes the spindle 140 to translate away from the plug and thereby disengage the clutch surfaces 152, 246. More specifically, rotating the plug 220 in the manner T causes the clevis 200 to translate away from the plug via the threaded interface 202, 242. This, in turn, causes the axle 160 and spindle 140 connected thereto to translate away from the plug 220. The spindle 140 rotates out of the away through the threaded interface 132, 154 with the nut 124 in order to allow for disengagement of the clutch surfaces 152, 246. Once the malfunction has been corrected, e.g., power restored, the process is reversed and the cap 290 re-installed to reset the electromagnet assembly 250 and clutch mechanism 180.

It will be appreciated that although the caliper assemblies 60, 390 are shown and described as dual piston assemblies on a single side of the rotor, each respective caliper assembly can alternatively be configured as a single piston assembly or alternatively have more than two pistons. In such constructions, the clutch unit 180 would be duplicated accordingly to populate pistons which must also include the parking function.

Moreover, one or more pistons can be provided on the inboard side of the rotor (as shown in FIG. 3A), the outboard side of the rotor, or both sides of the rotor. A caliper assembly can be associated with any number of these pistons. For example, caliper assemblies can be provided on both sides of the rotor 38 of FIG. 3A and secured to one another such that the piston(s) on opposite sides of the rotor oppose one another (not shown). That said, one or more pistons can be provided on one or both sides of the rotor and operate with an associated clutch unit as previously discussed. To this end, the coils 254 of all four electromagnetic assemblies 250 in such configurations can be wired together in parallel.

The caliper assemblies 60 shown and described herein can be used in different configurations within the vehicle 20 depending on several factors, including the type of vehicle in which braking is desired. For example, and referring back to FIG. 1, current, motor-driven EPB systems (not shown) might be used solely with the rear wheels 32 or on at least one front wheel 30. In accordance with the present invention, any of the caliper assemblies 60 can be provided for all four wheels 30, 32 in the case of light duty vehicles. Alternatively, any of the caliper assemblies 60 can be provided on the front wheels 30 to supplement motor-driven EPB systems provided on the rear wheels 32 in the case of medium duty or heavy duty vehicles.

It will also be appreciated that the number of piston assemblies 100 and orientation thereof within the caliper assembly 60 can be different from that shown and described. To this end, the calipers assemblies 60 can each have one, two, four, or six pistons. The caliper assemblies 60 can be fixed (opposing pistons) or floating (pistons on only one side).

Moreover, all the piston assemblies 100 in a particular caliper assembly 60 can include the clutch mechanism 270 or less than all the piston assemblies can include the clutch mechanism. For instance, in a fixed, six-piston caliper assembly 60 the clutch mechanisms 270 could be provided only on the middle two [opposing] piston assemblies 100. In another example, a six-piston caliper assembly 60 four of the piston assemblies 100 include the clutch mechanism 270, e.g., two on the leading side and two on the trailing side inboard/outboard. That said, the present invention provides great flexibility to accommodating any number of desired caliper assembly designs and parking brake methodologies.

In the present example, the motor-less caliper assembly 60 is shown on all four wheels 30, 32. With this in mind, the braking system 10 of the present invention can rely on sensed vehicle conditions to determine when service brake and/or parking brake actuation is desired. To this end, the control system 44 continuously monitors signals received from the sensors 48, 50, 52, 54 and controls the service brake and/or parking brake accordingly. More specifically, the control system 44 can rely on a series of sequential steps illustrated in FIG. 14.

In FIG. 14, the integrated brake control (IBC) system of the vehicle 20 is operational/available. The control system 44 continuously scans for parking brake related events. With this in mind, at step 400, the control system 44 determines that a parking brake apply event is detected. At step 402 the control system 44 checks whether the vehicle speed is below a predetermined threshold value, e.g., less than about 5 km/h. To this end, the control system 44 evaluates the signals received from the vehicle speed sensor 50.

If the vehicle speed is below the threshold value, at step 404, the control system 44 determines whether the vehicle 20 is stationary based on the vehicle speed sensor 50. If “no”, at step 406 the control system 44 evaluates the signals from the road grade sensor 52 and applies the service brake accordingly until the control system 44 determines the vehicle 20 is stationary.

On the other hand, if the detected vehicle speed is not below the threshold value at step 402, at step 408 the control system 44 alerts the vehicle 20 driver, e.g., informs the driver via the alert 56 that services brakes will be applied, and automatically applies the service brake. In one example, the control system 44 applies hydraulic pressure to the caliper assemblies to decelerate the vehicle 20 at 0.3 g (or current OEM requirement) or, if the brake pedal is applied by the driver, at a deceleration corresponding to the brake pedal position from the sensor 48. In any case, the service brake is applied and the control system 44 checks whether the vehicle is stationary at step 410 until the inquiry is answered in the affirmative.

That said, once the vehicle 20 is stationary, at step 420 the control system 44 increases the hydraulic pressure at the caliper assemblies based on the both the road grade as well as the expected clamp drop-off. By “expected clamp drop-off”, it is to be understood to mean the amount of clamping force expected to be lost in the transition between service braking and applying the parking brake. At step 422, the control system 44 actuates the clutch mechanism(s) to the second condition, thereby applying and maintaining the parking brakes. The program ends at step 424.

When a parking brake release event is detected at step 430, the control system 44 increases the hydraulic service brake pressure to, for example, 10% greater than the last-applied service brake hydraulic pressure. At step 434, the control system 44 actuates the clutch mechanism(s) to the first condition, thereby releasing the parking brakes. At step 436, the program ends. It will be appreciated that the parking brake release event could be, for example, sensing that the accelerator pedal is depressed greater than about 5% of its maximum stroke, i.e., a drive-away release (DAR).

By using a magnetic-driven, motor-less clutch mechanism in lieu of a mechanical one, the present invention advantageously alleviates the need to have a clutch mechanism shaft extending from the atmospheric side of the caliper assembly to the pressure side. Instead, the magnetic fields generated between the electromagnet assembly and permanent magnet passes between the atmospheric side and the hydraulic side.

With this in mind, the magnetic field is capable of passing through a seal, e.g., part of the housing or an additional membrane, sealing off the atmospheric side from the hydraulic side. Consequently, the clutch mechanism and hydraulic service braking operate wholly independent from one another and, thus, the torque needed to rotate the clevis is independent from any fluid pressure already present in the caliper assembly at the time the parking brake is applied. Using a magnetic field instead of a shaft that would pass from the atmospheric side to the hydraulic side to operate the clutch mechanism advantageously facilitates rotating the fast lead spindles at pressure and rotating the clevis independent of the applied hydraulic pressure.

It will also be appreciated that although the caliper assembly is shown and described as a dual piston assembly on a single side of the rotor, the caliper assembly can alternatively be configured as a single piston assembly. Since each piston assembly includes its own clutch mechanism and electromagnet assembly, modifying the number of pistons likewise modifies the number of clutch mechanisms and electromagnet assemblies.

The caliper assemblies of the present invention are advantageous for several reasons. First, utilizing an electromagnet to actuate the parking brake advantageously reduces the size of the locking mechanism and allows the locking mechanism to operate with reduced power. More specifically, the current/power draw for the electromagnet could be fulfilled with a small, on-board battery as opposed to relying on the vehicle battery. Using a motor-less clutch mechanism can also allow for the removal of other traditional caliper assembly components such as transmission parking pawls. The clutch mechanism also advantageously operates independent from the hydraulic fluid pressure in the caliper assembly, thereby making the design simpler and facilitates rotation of not only the locking arm but also between the fast lead connection.

Second, the clutch mechanism described herein allows the caliper assemblies to maintain their clamping force, e.g., up to and exceeding about 90 kN, even when the hydraulic pressure is removed. This provides redundant braking control in the event of hydraulic system failure during parking brake application and/or a service brake mechanical push-through situation. Furthermore, the fast lead connection between the nut and spindle provides rapid clamping apply and release times, e.g., less than about 1.2 s in each direction, less than about 0.8 s in each direction, or less than about 0.3 s in each direction, with minimal resistive load on the piston and/or spindle. The fast lead also enables the clutch mechanism to operate with minimal current draw.

Third, the caliper assemblies may also be used on the front wheels of a vehicle because they are very compact in size. Additionally, the motor-less caliper assembly described herein can supplement the total vehicle parking capacity of motor-driven EPB systems. Consequently, the size of the motor-driven EPB systems can be advantageously reduced, with a reduced braking force requirement needed at each vehicle corner. Moreover, the motor-less caliper assemblies can be readily implemented in any hydraulic-based service braking system—including opposed piston constructions.

Moreover, the phenolic piston is specifically designed to help withstand and distribute loads experienced by the piston assembly during braking operations. In particular, the radially extending shoulder on the phenolic piston has an extended length to help minimize the tensile load at the interface between the inner diameter of the shoulder and the main body of the piston (the radially innermost point of the surface 114). This interface is stressed in shear during brake apply when the flange of the nut presses on the shoulder of the piston to apply the brakes.

Along those lines, the threaded connection between the spindle and nut is also specifically designed to help mitigate undesirable off axis loading on the piston assembly. To this end, the cooperating threads on the spindle and nut each have shallower depths compared to existing spindle-to-nut connections. As a result, the threaded connection experiences lower bending moments during braking events.

Moreover, providing the spindle with shallow threads enables the root diameter of the spindle to approximate the contact diameter between the spindle and nut, which thereby advantageously allows the clutch contact radius between the spindle and the plug to increase while the backdrive diameter is reduced as much as possible toward the clutch contact radius.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A parking brake for a wheel rotor having at least one brake pad associated therewith, comprising:
a housing defining first and second passages;
first and second pistons provided in the respective first and second passages;
first and second spindles associated with each of the respective first and second pistons such that axial translation of the pistons causes rotation of the spindles;
a clutch mechanism associated with each of the first and second spindles, each clutch mechanism having a first condition allowing relative rotation between the spindles and the pistons such that the pistons are axially movable within the passages and into engagement with the at least one brake pad in response to hydraulic pressure applied to the pistons, each clutch mechanism having a second condition preventing relative rotation between the spindles and the pistons such that the pistons remain engaged with the at least one brake pad when hydraulic fluid pressure is removed from the pistons to maintain clamp force at the vehicle wheel; and
an electromagnet assembly associated with each clutch mechanism, each electromagnet assembly having a first magnetic polarity for placing the clutch mechanism in the first condition and having a second magnetic polarity for placing the clutch mechanism in the second condition.

2. The parking brake of claim 1, wherein each electromagnet assembly comprises:
an electromagnetic coil;
legs extending from the coil; and
a permanent magnet positioned between the legs, wherein the coil is given the first magnetic polarity for rotating the permanent magnet to a first orientation to thereby place the clutch mechanism in the first condition and wherein the coil is given the second magnetic polarity for rotating the permanent magnet to a second orientation to thereby place the clutch mechanism in the second condition.

3. The parking brake of claim 2, wherein the legs first repel then, in response to permanent magnet rotation, attract the permanent magnet when the coil is given the first magnetic polarity to place the permanent magnet in the first orientation.

4. The parking brake of claim 2, wherein the legs first repel then, in response to permanent magnet rotation, attract the permanent magnet when the coil is given the second magnetic polarity to place the permanent magnet in the second orientation.

5. The parking brake of claim 2, wherein each clutch mechanism comprises:
a plug for receiving the permanent magnet; and
a clevis fixed for axial movement with the respective spindle and being rotatable with the permanent magnet relative to the plug.

6. The parking brake of claim 5, wherein the plug includes a clutch surface and the respective spindle includes a corresponding clutch surface, and wherein the clevis rotates in a first direction for engaging the clutch surfaces to prevent relative rotation between the spindle and the piston and rotates in a second direction for disengaging the clutch surfaces to allow relative rotation between the spindle and the piston.

7. The parking brake of claim 6, wherein the clevis has a threaded connection with the plug such that changing the orientation of the permanent magnet causes the clevis to translate with the spindle through the threaded connection.

8. The parking brake of claim 6, wherein the clutch surfaces encircle the clevis.

9. The parking brake of claim 6, wherein the clutch surfaces are domed to allow spindle articulation on the plug due to deflection of the housing in response to varying clamp loads.

10. The parking brake of claim 5, wherein the clevis has a threaded connection with the plug and an axle connects the spindle to the clevis such that the spindle and clevis move together axially while permitting relative rotation between the spindle and the clevis.

11. The parking brake of claim 1, wherein the spindles have a fast lead threaded connection with each piston.

12. The parking brake of claim 1, wherein the clutch mechanism is motor-less.

13. The parking brake of claim 1, wherein the electromagnet assembly and the housing cooperate to define a hydraulic side of the parking brake and an atmospheric side, and wherein the electromagnet assembly generates a magnetic field that passes between the atmospheric and hydraulic sides for controlling the positions of the pistons relative to the at least one brake pad.

14. A parking brake for a wheel rotor having at least one brake pad associated therewith, comprising:
a housing defining at least one passage;
a piston provided in each passage;
a spindle associated with each piston such that axial translation of the piston causes rotation of the respective spindle;
a clutch mechanism associated with each spindle, each clutch mechanism having a first condition allowing relative rotation between the spindle and the respective piston such that the piston is axially movable within the passage and into engagement with the at least one brake pad in response to hydraulic pressure applied to the piston, each clutch mechanism having a second condition preventing relative rotation between the spindle and the respective piston such that the piston remains engaged with the at least one brake pad when hydraulic fluid pressure is removed from the piston to maintain clamp force at the vehicle wheel; and
an electromagnet assembly associated with each clutch mechanism, each electromagnet assembly having a first magnetic polarity for placing the clutch mechanism in the first condition and having a second magnetic polarity for placing the clutch mechanism in the second condition.

15. The parking brake of claim 14, wherein each electromagnet assembly comprises:
an electromagnetic coil;
legs extending from the coil; and
a permanent magnet positioned between the legs, wherein the coil is given the first magnetic polarity for rotating the permanent magnet to a first orientation to thereby place the clutch mechanism in the first condition and wherein the coil is given the second magnetic polarity for rotating the permanent magnet to a second orientation to thereby place the clutch mechanism in the second condition.

16. The parking brake of claim 15, wherein the legs first repel then, in response to permanent magnet rotation, attract the permanent magnet when the coil is given the first magnetic polarity to place the permanent magnet in the first orientation.

17. The parking brake of claim 15, wherein the legs first repel then, in response to permanent magnet rotation, attract the permanent magnet when the coil is given the second magnetic polarity to place the permanent magnet in the second orientation.

18. The parking brake of claim 15, wherein each clutch mechanism comprises:
a plug for receiving the permanent magnet and including the second clutch surface; and
a clevis fixed for axial movement with the spindle and being rotatable with the permanent magnet relative to the plug, wherein the clevis rotates in a first direction for engaging the clutch surfaces and in a second direction for disengaging the clutch surfaces.

19. The parking brake of claim 14, wherein the housing defines an even number of passages arranged on either only one side or both sides of the wheel rotor such that an even number of pistons are movable into engagement with the at least one brake pad.

20. The parking brake of claim 14, wherein the clutch surfaces are domed to allow spindle articulation on the plug due to deflection of the housing in response to varying clamp loads.
